(19) United States
(12) Patent Application Publication
(10) Pub. No.: US 2009/0308521 A1
(43) Pub. Date: Dec. 17, 2009

(54) Compression-selective sheet-material density and thickness and methodology

(75) Inventors: Russell A. Monk, Salem, OR (US); Lance A. Hicks, Salem, OR (US)

Correspondence Address: ROBERT D. VARITZ, P.C., 4915 SE 33RD PLACE, PORTLAND, OR, 97202, US

(73) Assignee: High Impact Technology, L.L.C.

(21) Appl. No.: 12/456,004

(22) Filed: Jun. 10, 2009

Related U.S. Application Data
(60) Provisional application No. 61/131,805, filed on Jun. 12, 2008.

(51) Int. Cl. B32B 37/00

(52) U.S. Cl. 156/60

(57) ABSTRACT

A heat and pressure method for creating, from plural, unconsolidated, composite, heat-and-pressure-formable, compressible starter materials having an initial, combined-material starter density D₁ and starter thickness T₁, a composite-material structural panel having a combined-material density D₂ and thickness T₂, where D₁ is less than D₂ and T₁ is greater than T₂. The method includes the steps of (a) selecting starter materials having known, respective, nominal density and thickness characteristics, (b) creating an unconsolidated stack of such materials to have a combined-material density D₁ and thickness T₁, (c) applying heat and pressure to that stack, and (d) thereby consolidating and compressing the stack to produce the desired, finished structural panel possessing an overall, combined-material density D₂ and thickness T₂.

### CROSS REFERENCE TO RELATED APPLICATION

This application claims priority to currently co-pending U.S. Provisional Patent Application Ser. No. 61/131,805, filed Jun. 12, 2008, for “Compression-Selective Sheet-Material Density and Thickness and Methodology”. The entire disclosure content of that copending provisional application is hereby incorporated herein by reference.

### BACKGROUND AND SUMMARY OF THE INVENTION

This invention pertains to producing user-determinable, defined-thickness and defined-effective-density structural panels that are characterized with lower-density core structure which is clad on opposite, broad faces by higher-density facing structure. More particularly, the invention, using appropriate heat and compression, concerns producing, as desired, a consolidated, layered, composite-material structural panel of the character just outlined having a desired, final, composite, or effective, density D₂, and a composite thickness T₂, from a stack of plural, unconsolidated, different-material layers of heat-and-pressure-formable (thermoformable) starter materials, each having a respective, but different, starter density D_{S} and starter thickness T_{S}, with the unconsolidated stack collectively possessing a starter, composite, effective density D₁ which is less than D₂, and a starter, composite thickness T₁ which is greater than T₂.

In the description of the invention furnished herein, an “effective” density of an assembly of combined materials is determined by the ratio of their combined overall mass to their overall volume.

In the background setting for this invention, there are many building, and other, applications wherein it is desired to employ, if possible, specific structural panel materials that have desired, nonconventional thickness and effective functional-density, including internal, differentiated density characteristics, such as lower-density core structures clad by higher-density, opposite-surface facing structures. In these circumstances, it is often difficult, or impossible, to find ready-to-use structural panel materials having such specific characteristics.

The present invention recognizes and addresses this concern and consideration, and proposes a technique, stated generally in the opening paragraph of this text above, whereby plural, differentiated-thickness-and-density-characteristic starter materials, and specifically thermoformable starter materials, may be pre-selected, stacked, and then consolidated under the application of pressure and heat to produce, by design, a structural panel product which has substantially exactly the desired thickness and internally-differentiated, effective functional-density properties suited to a particular application.

The invention thus offers an opportunity for designers of structures intended to employ special-character structural panels to design such panels in a manner enabling a user to employ exactly the right kind of panel in accordance with special thickness and density design specifications.

Structural panels formed by the practice of the present invention, which is very versatile, may, accordingly, readily be tailor-made to meet a large array of use requirements and environments.

For the purposes of description and illustration herein, a preferred manner of practicing the invention is described in conjunction with starter materials taking the two, specific forms of (a) strand-fiber-reinforced (aramid strand-reinforced, such as E-glass strand-reinforced) plastic material, and (b) PET (polyethylene terephthalate) material. The plastic substances employed in these two different types of illustrative starter materials are chosen with characteristics enabling them to be readily configurationally formed (compressed and shaped) by and with applied heat (in the range of around 350-400° F.) and pressure (in the range of about 5-30-lbs/in²).

From the detailed description of the invention which is presented below, those generally skilled in the relevant art will understand, and know about, and will know how to make, choices with respect to, other specific pressure-and-heat-formable materials that may be employed in the practice of the invention.

We have found that a very useful way of practicing the invention involves beginning with the assembly of an unconsolidated stack of thermoformable layer materials including a core material which has a relatively low density and large thickness, clad or sandwiched between two, much thinner layers, preferably strand-reinforced layers, which have a much higher density.

Appropriate pre-determinations are made regarding what the desired final thickness and composite density should be for a finished structural panel made in accordance with the invention, and this consideration leads to a predetermination of the relative thicknesses and densities of the “starter materials” which should be employed. The selected starter materials are referred to herein as having known and prechosen, nominal D/T density/thickness characteristics

The starter-material densities and thicknesses will result, in accordance with practice of the invention, in an initial, unconsolidated layer arrangement having an overall starter thickness and an overall, composite-material effective density, whose values will necessarily change during panel formation which involves the application of appropriate heat and compression pressure to consolidate the assembled starter materials into a final panel product. The final panel product will, with all preliminary selections of nominal density and thickness values appropriately chosen, result in a panel having the desired final thickness and composite density which are, respectively, smaller and larger than the thickness and density values associated with the unconsolidated materials.

In a more formal way of thinking about the practice of the invention which has just now above been generally described, the practice of the present invention may, in high-level terms, be described as:

A heat and pressure method for creating a desired and finished, layer-consolidated, composite-material structural panel having a predetermined, combined-material effective density D₂, and thickness T₂, from layer-unconsolidated, composite, heat-and-pressure-formable starter materials having a predetermined, combined-material effective starter density D₁, and starter thickness T₁, where D₁ is less than D₂ and T₁ is greater than T₂.

The method steps include:

(a) selecting starter materials each having respective, known, prechosen, nominal D/T (density D and thickness T) characteristics;

(b) based upon these D/T characteristics, creating a precursor, unconsolidated stack of such materials having a combined-material effective density D₁, and thickness T₁;

(c) applying heat and pressure to that stack; and

(d) utilizing such heat and pressure application, consolidating the stack to produce the desired, finished structural panel possessing an overall, combined-material effective density D₂, and thickness T₂.

The various important features, and the offered advantages, of the methodology (and of certain suggested variations and modifications) proposed by the present invention which are now presented below will be readily understood when the detailed description of the invention is read in conjunction with the illustrations presented in the accompanying drawings.

### DESCRIPTIONS OF THE DRAWINGS

FIG. 1 is a fragmentary, cross-sectional view of an unconsolidated layer (layer-unconsolidated) arrangement of starter materials employed herein to illustrate the practice of the present invention.

FIG. 2 is a view which is similar to that presented in FIG. 1, but here showing the layer arrangement of FIG. 1 in a post-heat-and-pressure-formed, consolidated state referred to herein as a layer-consolidated condition—a condition illustrating a thickness and density-controlled structural panel which has been produced in accordance with the preferred practice of the invention.

FIG. 3 is a view which is similar to that presented in FIG. 2, with the exception that it shows a differentiated final thickness, and differentiated final density, final, composite-material panel which has been formed utilizing the practice steps of the invention.

### DETAILED DESCRIPTION OF THE INVENTION

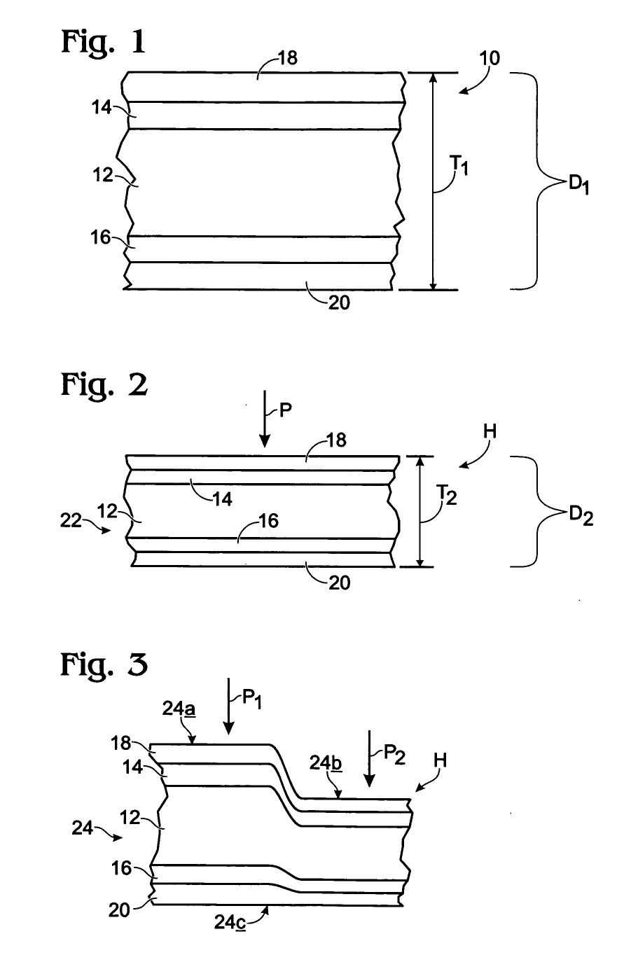

Turning now to the drawings, and referring first of all to FIG. 1, indicated generally at 10, in a fragmentary fashion, is a portion of what is referred to herein as a layer-unconsolidated stack of starter materials that are heat-and-pressure formable, i.e., pressure-thermoformable, in nature, and which have been prepared in accordance with practice of the present invention to create, ultimately, what is referred to herein as a desired and finished, layer-consolidated, composite-material structural panel. FIG. 2 illustrates the finished, desired, consolidated panel which results from practice of the invention with respect to the unconsolidated stack of materials shown in FIG. 1.

For the purpose of illustration herein, the layers of materials which have been chosen to create the finished panel shown in FIG. 2 include a core layer 12 formed of thermoformable and compressible polyethylene terephthalate, also referred to herein as PET, and on opposite faces of this core layer, two-each cladding layers 14, 16 (inner) and 18, 20 (outer) formed of fibre; or strand-, reinforced, polymeric thermoformable 9 And compressible) plastic, wherein the strands (that are not specifically illustrated in the drawings) are formed of aramid, E-glass strands. The plastic in the core layer is compatible with that in the cladding layers.

These illustrative layers, or sheets, of material which make up stack 10 have perimetral dimensions herein of 3-feet by 4-feet. The selected, PET core-12 material has a starter thickness T₁ of 1-inches, and a nominal, or starter, density of 6-lbs/ft³. A very suitable choice for this material is that which is made and sold by Sealed Air Corporation in Saddlebrook N.J. under the product designator 6-24#.

The four, thermoformable cladding layers 14, 16, 18, 20 are preferably formed herein, also for illustration purposes, of 0.020-inch thickness material made by Polystrand, Inc. in Montrose, Colo., sold under the trademark Polystrand®, and possessing a nominal, or starter, density of 120-lbs/ft³.

The starter density and thickness characteristics of these two different kinds of layer materials are referred to herein collectively as D/T nominal, starter characteristics. The starter thickness of the each of the core and cladding layers is also referred to herein with the general verbal designator T_{S}, and the starter density of each of the starter materials is referred to generally with the general verbal designator D_{S}.

Given the dimensional and density starter information just presented above, stack 10 has a starter, consolidated-material thickness of 1.08-inches, a starter weight of 44.4-lbs, a starter volume of 1.32-feet³, and an unconsolidated, effective, composite-material, starter density of 36.6-lbs/ft³. This starter effective density if represented in FIG. 1 by bracket D₁.

From the starting, unconsolidated thickness and density conditions just described, and still for illustration purposes herein, it is intended that, by practice of the invention, stack 10 will be consolidated (compressed) under pressure (in the range of about 5-30-lbs/in²) and applied heat (in the range of about 350-400° F.), represented by P and H, respectively, in FIG. 2, to achieve a finished, composite-material panel product which has a consolidated, overall, uniform thickness T₂ of ½-inches, and a consolidated, composite-material effective density (bracket D₂) of 88.8-lbs/ft³.

These final consolidated conditions are in fact the ones which are illustrated fragmentarily in FIG. 2 for the finally formed, desired panel which is shown at 22 in this figure. Appropriate consolidation pressure and temperature to accomplish this may involve a pressure P of about 15-lbs/in², and a temperature H of about 375° F.

From the invention description which has just been given, it will be apparent to those skilled in the art how it is possible to achieve, from starter-material nominal thicknesses and densities that have been carefully pre-chosen and preselected, final, desired, composite-material structural panels possessing overall final thicknesses, and final, composite-material, effective densities, having desired and pre-planned values. More specifically, those skilled in the art, from the description of the invention practice which is set forth above, should gain a very solid knowledge about how to create a very wide variety of structural panels, like the panel shown in FIG. 2, to meet and be usable in a very wide variety of structural-panel-requiring applications.

Turning attention now to FIG. 3, here there is generally illustrated at 24, a differentiated final thickness, and differentiated final density, final, composite-material panel which has been formed utilizing the practice steps of the invention expressed above. As can be seen, panel 24 includes a thicker portion 24a, a thinner portion 24b, and a transition portion, or region, 24c extending between and joining the thicker and thinner regions. This panel has been formed from a starter, unconsolidated stack of the very same material layers which are shown in FIGS. 1 and 2, specifically including a core layer 12 of PET material, and opposite-face cladding layers formed of Polystrand® material 14, 16, 18, 20.

Heating and pressure application to achieve the configuration illustrated in FIG. 3 may involve a heating temperature H of about 375° F., and differential pressures, illustrated at P₁ and P₂ in FIG. 3, of about 10-lbs/in² and 15-lbs/in², respectively. In the final structural panel illustrated in FIG. 3, thicker region 24a has a final thickness of about ¾-inches, and thinner portion 24b, a thickness of about ½-inches, with respective, consolidated-material effective densities being about 61.2-lbs/ft³, and 88.8-lbs/ft³.

Accordingly, a preferred and best mode embodiment of, and manner of practicing, the present invention have been described and illustrated in a manner which should well-equip those generally skilled in the relevant art to prepare final, composite-material structural panels having desired and pre-determined final thicknesses and effective composite densities suited to a wide variety of applications. As has been mentioned, certain preferred materials and layer arrangements have been illustrated and described specifically for the purpose of disclosing the key features of the invention, with the full understanding that various other, suitable thermoformable materials in different layer arrangements may similarly be employed. The manners of pre-determining what starter materials to use, and what nominal density and thickness characteristics to select in order to achieve a final panel product having the final thickness and effective density characteristics desired, should be clearly evident.

Accordingly, in the context of what has been disclosed and described herein, we appreciate that numerous variations and modifications may be made within, and without departing from, the spirit of the invention.

We claim:

1. A heat and pressure method for creating a desired and finished, layer-consolidated, composite-material structural panel having a predetermined, combined-material effective finished density D₂, and thickness T₂, from layer-unconsolidated, composite, heat-and-pressure-formable and compressible starter materials having a predetermined, combined-material effective starter density D₁, and starter thickness T₁, where D₁ is less than D₂ and T₁ is greater than T₂, said method comprising
selecting starter materials each having respective, known and prechosen, nominal D/T (density D and thickness T) characteristics,
based upon the mentioned, known nominal D/T characteristics, creating a precursor, unconsolidated stack of such materials having a combined-material effective density D₁, and thickness T₁,
applying heat and pressure to that stack, and
utilizing such heat and pressure application, consolidating and compressing the material stack to produce the desired, finished structural panel possessing an overall, combined-material effective density D₂, and thickness T₂.

2. The method of claim 1, wherein said selecting involves picking starter materials that are of two different types, one of which takes the form of a strand-reinforced, heat-and-pressure-formable, compressible plastic material, and the other of which takes the form of heat-and-pressure-formable, compressible PET material, and said stack-creating involves preparing a layer arrangement defined by a core layer of the PET material sandwiched between layers of the strand-reinforced material.

3. The method of claim 2, wherein the picked core-material layer is chosen to have a nominal thickness which is greater than the combined thicknesses of the picked strand-reinforced material layers.

4. The method of claim 3, wherein the picked core-material is chosen to have a nominal density which is less than that of the picked strand-reinforced material.
